(19) United States
(12) Patent Application Publication
(10) Pub. No.: US 2013/0175719 A1
(43) Pub. Date: Jul. 11, 2013

(54) Method For Fabricating Porous UO2 Sintered Pellet For Electrolytic Reduction Process For Recovering Metallic Nuclear Fuel Using Continuous Process Of Atmospheric Sintering And Reduction, And Porous UO2 Sintered Pellet Fabricated By The Same

(71) Applicant: Korea Atomic Energy Research Institute, Daejeon (KR)

(72) Inventors: Sang-Ho NA, Daejeon (KR); Jin-Myeong Shin, Daejeon (KR); Jang Jin Park, Daejeon (KR)

(73) Assignee: Korea Atomic Energy Research Institute, Daejeon (KR)

(21) Appl. No.: 13/709,973

(22) Filed: Dec. 10, 2012

(30) Foreign Application Priority Data
Dec. 13, 2011 (KR) 10-2011-0133508

(51) Int. Cl. G21C 19/42

(52) U.S. Cl. CPC G21C 19/42
USPC 264/5

(57) ABSTRACT

A method for fabricating porous UO₂ sintered pellets to be fed into an electrolytic reduction process for the purpose of metallic nuclear fuel recovery is provided, which includes forming a powder containing U₃O₈ by oxidizing a spent nuclear fuel containing uranium dioxide (UO₂) (step 1), fabricating U₃O₈ green pellets by compacting the powder formed in step 1 (step 2), and fabricating UO₂ sintered pellets by sintering the U₃O₈ green pellets fabricated in step 2 at 1000 to 1600° C., in an atmospheric gas, and cooling the same for reduction, by changing the atmosphere to a reducing atmospheric gas (step 3). The porous UO₂ sintered pellets can be fabricated, which do not have any defects. The volatile fission products are sufficiently removed from the fabricated porous UO₂ sintered pellet, the O/U ratio is 2.00, the permeation of the electrolyte during reduction is facilitated, and the electrolytic reduction velocity increases.

### BACKGROUND OF THE INVENTION

1. Field of the Invention

The present invention relates to a method for fabricating porous UO₂ sintered pellets for an electrolytic reduction process for recovering metallic nuclear fuel, and porous UO₂ sintered pellets fabricated in the same way, and more particularly, to a method for fabricating porous UO₂ sintered pellets for an electrolytic reduction process by continuously performing atmospheric sintering and reduction to recover the metallic nuclear fuel.

2. Description of the Related Art

Spent nuclear fuel (UO₂) from a light water reactor (LWR) generally includes fissile material (U) that is not consumed, and transuranic elements (TRU) that are generated from the burning. Along with this, UO₂ also includes fission products. The pyroprocess is a recycle technology implemented to produce metallic nuclear fuel for use in a fast reactor, through pyrometallurgical and electrochemical processing from irradiated UO₂ fuel in the LWR, thus providing advantages including good nuclear proliferation resistance. To recover the fissile material, the pyroprocessing mainly includes a pretreatment process to fabricate UO₂ sintered pellets from U₃O₈ powder, and a follow-up process to convert the fabricated UO₂ sintered pellets (i.e., ceramic nuclear fuel) into metallic nuclear fuel. The presence of fission products is desirably removed in the pretreatment process in consideration of the considerable influence on the follow-up process where the ceramic fuel is converted into metallic fuel. To be specific, the pretreatment process generally involves disassembly/cutting of a fuel rod, decladding, compacting, and sintering, and the follow-up process mainly involves electrolytic reduction, electro-refining, and electro-winning (see FIG. 1). The decladding in the pretreatment process relates to extracting spent UO₂ sintered pellets from the disassembly/cut fuel rod, in which the UO₂ sintered pellets within the fuel rod are generally converted into U₃O₈ in an air atmosphere at temperatures ranging between 350 and 700° C. The UO₂ pellets are powdered owing to a volume expansion in accordance with the decreased density, and thus escapes from the fuel rod. As the phase changes from UO₂ pellets to U₃O₈ powder from oxidation, gaseous volatile fission products including iodine (I) and bromine (Br) existing in the pellet are vaporized.

After the decladding, the U₃O₈ powder is compacted into the desired shapes and dimensions using a compacting machine such as a press. Then, by sintering at the appropriate temperature under desired atmospheric gas (e.g., oxidizing, inert, nitrogen, and reducing gas), porous sintered pellets are fabricated, and are suitable for a volatilization of the fission products and are suitable for handling. Porous UO₂ sintered pellets are advantageous, considering the fact that fission products are easily volatilized, and when the following electrolytic reduction is processed with UO₂ rather than U₃O₈, the O/U ratio is decreased from 2.67 to 2.00, and owing to the decrease in the existing oxygen, the processing efficiency is increased greatly. Further, the process yield is increased, such that there is an advantage of increased productivity.

In a conventional technology, the U₃O₈ powder is compacted, and sintered for a predetermined time in an oxidizing, inert, or nitrogen (N₂) gas atmosphere, and thus UO₂₊ₓ sintered pellets (not porous UO₂) are fabricated. If U₃O₈ green pellets are sintered for a predetermined time in a reducing atmosphere, it would be possible to fabricate porous UO₂ sintered pellets. However, considering the fact that a low sintering temperature even in a reducing atmosphere will result in the fabrication of UO₂₊ₓ (x=0.01-0.13) sintered pellets having a O/U ratio (i.e., ratio between oxygen elements to uranium elements) other than 2.00, it is necessary that the temperature be at least 1400° C. or greater to ensure that the porous UO₂ sintered pellets are fabricated (see FIG. 1). Further, upon observation of the fracture surface of the sintered pellet fabricated in a reducing atmosphere, if the sintering temperature was relatively lower (i.e., lower than or equal to 1200° C.), there were relatively more inter-particle bonded aggregates of the powder, while at relatively higher sintering temperature (i.e., higher than or equal to 1400° C.), there were independently-existing powder particles, and inter-particle bonding was not observed (see FIG. 2). This indicates the fact that, above or equal to 1400° C., U₃O₈ is completely reduced into UO₂, thereby removing inter-particle bonding.

Meanwhile, after U₃O₈ powder extracted from the fuel rod are compacted into a desired shape (cylindrical or cubical shape) and dimensions using a press, pores suitable for the volatilization of the fission products in the pellet are massively generated during sintering in an atmospheric gas (oxidizing, inert, reducing, and nitrogen). Owing to the presence of the pores generated as explained above, the semi-volatile fission products existing in the pellet matrix are allowed to be more easily volatilized, and as the atmospheric gas facilitates the volatilization of the fission products, the fission products are basically not remained in the pellet matrix.

Korean Patent No. 10-0293482, incorporated herein by reference in its entirety, teaches a method for fabricating UO₂ sintered pellets, which includes steps of fabricating green pellets by adding various kinds of sintering aids into oxidized U₃O₈ powder transformed from UO₂ spent nuclear fuel, and fabricating UO₂ sintered pellets by sintering the green pellets at temperatures above or equal to 1500° C. in a reducing atmosphere, thereby providing the advantage of providing UO₂ sintered pellets with high sintered density. However, when the sintering in a high-temperature reducing atmosphere above or equal to 1400° is performed, the powder particles are not linked, but exist independently from each other in the fabricated sintered pellets. If this happens, the sintered pellets do not maintain their shape and collapse into fragments in the follow-up process, i.e., the electrolytic reduction. The fragments will then cause additional shortcomings such as inconvenient handling in the follow-up process. Further, the additives, which are added to enhance the sintered density of the sintered pellet, unnecessarily remain to affect the process when the metallic fuel is recovered by electrolytic reduction. Further, since such fuels including additives will also produce undesirable fission products in large amounts when recycled at a later stage, recycling can be inefficient.

In awareness of the above, the present inventors have been investigating a method for fabricating porous UO₂ sintered pellets for an electrolytic reduction for the purpose of recovering metallic fuel from the spent nuclear fuel (UO₂), and were able to develop a method for fabricating porous UO₂ sintered pellets, which involves the steps of oxidizing the spent nuclear fuel (UO₂) into U₃O₈, compacting the result into green pellets, sintering the green pellets to remove volatile and semi-volatile fissionable products, and then continuously reducing the sintered pellets during cooling to have an O/U ratio of 2.00, and thus completed the present invention.

### SUMMARY OF THE INVENTION

The objective of the present invention is to provide a method for fabricating porous UO₂ sintered pellets for electrolytic reduction process for the purpose of recovering metallic nuclear fuel, by continuously performing atmospheric sintering and reduction, and porous UO₂ sintered pellets fabricated through the same method (see FIG. 3).

To accomplish the above-mentioned object of the present invention, a technical concept is to provide a method for fabricating porous UO₂ sintered pellets to be fed into an electrolytic reduction process for the purpose of metallic nuclear fuel recovery, which includes steps of (see FIG. 4): forming a powder containing U₃O₈ by oxidizing a spent nuclear fuel containing uranium dioxide (UO₂) (step 1), fabricating U₃O₈ green pellets by compacting the powder formed in step 1 (step 2), and fabricating UO₂₊ₓ sintered pellets by sintering the porous U₃O₈ green pellets fabricated in step 2 at 1000 to 1600° C. in an atmospheric gas, and cooling and reducing the same in a reducing atmosphere to form UO₂ sintered pellets (step 3).

Further, in one embodiment, porous UO₂ sintered pellets, which are fabricated according to the above-mentioned fabricating method, are provided.

Further, in one embodiment, a method for performing electrolytic reduction process using the porous UO₂ sintered pellets fabricated according to the above-mentioned fabricating method is provided.

According to a method for fabricating porous UO₂ sintered pellets for an electrolytic reduction for the purpose of metallic nuclear fuel recovery and porous UO₂ sintered pellets fabricated in the same way at the embodiments of the present invention, green pellets are obtained using U₃O₈ powder as a result of oxidizing spent nuclear fuel (i.e., UO₂), and volatile and semi-volatile fission products are removed through the pores generated in the high-temperature sintering, and the reduction is performed in a reducing atmosphere such that high-quality porous UO₂ sintered pellets with no defects such as cracks can be fabricated. The sintered densities of the porous UO₂ sintered pellets can be controlled using the process parameters such as compacting pressure and sintering temperature. Because the volatile fission products are sufficiently removed from the fabricated porous UO₂ sintered pellet, and the O/U ratio is 2.00, the permeation of the electrolyte during reduction is facilitated, and as a result, the electrolytic reduction velocity increases. As a result, the efficiency of the electrolytic reduction increases during the pyroprocessing performed for the purpose of metallic nuclear fuel recovery, and the operability of the electrolytic reduction is also improved. Furthermore, the fabricated sintered pellets have good rigidity, which enables easy handling and transport to the follow-up processes.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a flowchart schematically illustrating a pyroprocssing including a conventional sintered pellet fabricating process.

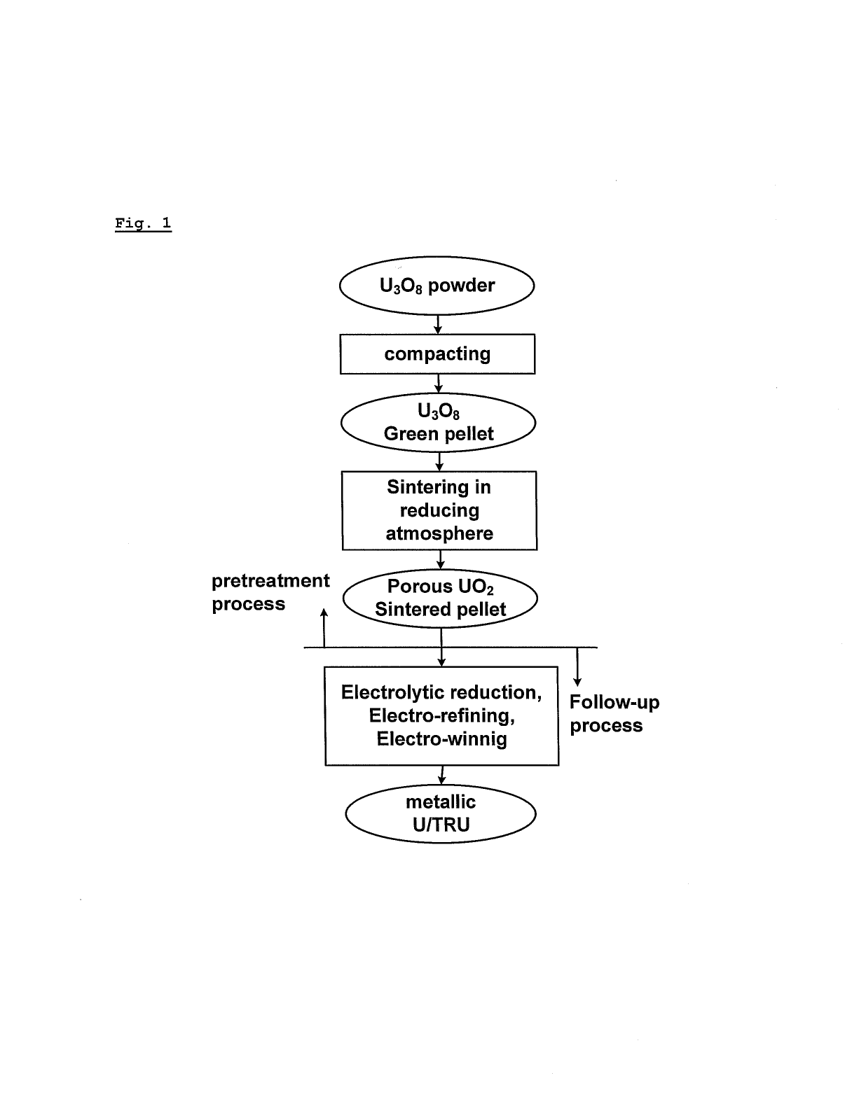

FIG. 2 shows SEM images of fracture surface of the porous UO₂ sintered pellet fabricated by sintering U₃O₈ green pellet for a predetermined time in a reducing atmosphere.

FIG. 3 is a graph plotting variations of temperature in accordance with time according to the fabricating method of an embodiment.

FIG. 4 shows a schematic flowchart provided to explain pyroprocessing including sintered pellets fabricating process according to an embodiment.

FIG. 5 shows SEM images of the fracture surface of the porous UO₂ sintered pellet fabricated according to Example 1.

FIG. 6 shows SEM images of the fracture surface of the porous UO₂ fabricated according to Example 2.

FIG. 7 shows SEM images of fracture surface of the porous UO₂ sintered pellet fabricated according to Example 3.

FIG. 8 shows SEM images of the fracture surface of the porous UO₂ sintered pellet fabricated according to Example 4.

### DETAILED DESCRIPTION OF THE INVENTION

Reference will now be made in detail to the embodiments of the present invention, the examples of which are illustrated in the accompanying drawings, wherein, like the reference numerals, refer to the like elements throughout. The embodiments are described below to explain the present invention by referring to the figures.

In one embodiment, a method is used for fabricating porous UO₂ sintered pellets for the electrolytic reduction process for the purpose of fission product removal and metallic nuclear fuel recovery, which may include the following steps: forming a powder containing U₃O₈ by oxidizing spent nuclear fuel containing uranium dioxide (UO₂) (step 1), fabricating green pellets by compacting the powder formed in step 1 (step 2), and fabricating UO₂₊ₓ sintered pellets by sintering the porous U₃O₈ green pellets fabricated in step 2 at 1000 to 1600° C. in an atmospheric gas, and cooling and reducing the same in a reducing atmosphere to form UO₂ sintered pellets (step 3).

The method for fabricating porous UO₂ sintered pellets for introduction into the electrolytic reduction process for the purpose of recovering metallic nuclear fuel will be explained step by step according to an embodiment.

The method used for fabricating porous UO₂ sintered pellets according to an embodiment may include a step of forming powder containing U₃O₈ by oxidizing spent nuclear fuel containing UO₂ (step 1).

In step 1, the U₃O₈ powder, as the raw material to be used in the fabrication of the porous UO₂ sintered pellet, may be formed from the spent nuclear fuel containing UO₂, by oxidizing the spent nuclear fuel containing UO₂ at 350 to 700° C. in an air atmosphere, however, considering the particle sizes of the oxidized powder and other various factors, the spent nuclear fuel containing UO₂ may preferably be oxidized at 400 to 500° C. If the spent nuclear fuel containing UO₂ is oxidized at a predetermined temperature in an oxidizing atmosphere, the spent nuclear fuel is oxidized into U₃O₈, along which the density decreases and the volume expands. As a result, the pellets are powdered. If the oxidization in step 1 is performed at temperatures lower than 400° C., time for oxidizing into U₃O₈ is lengthened, and it also takes a good deal of time until the spent fuel is extracted from the cladding tube. Further, if the oxidization in step 1 is performed at temperatures exceeding 500° C., owing to rapid U₃O₈ formation, controlling the particle size becomes difficult, and accordingly, coarse U₃O₈ particles appear.

According to an embodiment, the method used for fabricating porous UO₂ sintered pellets may include a step of fabricating green pellets by compacting the powder formed in step 1 (step 2).

In compacting the powder containing U₃O₈ formed in step 1, pressure for such compacting may preferably range between 100 and 500 MPa, and more preferably, between 150 and 450 MPa. If the pressure for compacting is below 100 MPa, the powder is not compressed sufficiently, thus degrading the integrity. This may also cause a shortcoming of inconvenient transport to the next process and inconvenient handling in the process. If the compacting pressure exceeds 500 MPa, the compression by excessive pressure causes a high-density of green pellets, and accordingly, the fission products are less likely to volatilize from the green pellets in the sintering process. In the fabrication of the green pellets using the pressure explained above, it is possible to adequately control the porosity of the green pellets by appropriately controlling the compacting pressure, and according to the adequate control of the porosity, it is possible to facilitate the volatilization of the fission products in the sintering process of the follow-up process.

Meanwhile, compacting may be performed using known methods including pressing. Although green pellets are preferable in a cylindrical or cubical shape suitable for the follow-up process, they are not limited thereto.

According to an embodiment, the method used for fabricating porous UO₂ sintered pellets may include a step for fabricating UO₂₊ₓ sintered pellets by sintering the porous U₃O₈ green pellets at a temperature between 1000 and 1600° C. in an atmospheric gas and while cooling the sintered pellets, reducing the pellets in a reducing gas to thus form porous UO₂ sintered pellets (step 3).

Since power containing U₃O₈ formed from spent nuclear fuel generally includes various kinds of semi-volatile and volatile fission products, considering the potential risk of a negative effect on the electrolytic reduction process wherein ceramic fuel is reduced into metallic nuclear fuel, it is preferable to vaporize the fission products during the pretreatment by heating at the appropriate temperature; it is also desirable to filter the vaporized fission product.

To remove the fission product, step 3 may include a step of sintering the U₃O₈ green pellets formed in step 2 at a temperature between 1000 and 1600° C., and removing, by vaporizing, the nuclear fission product from the U₃O₈ green pellets through many pores that are generated during the sintering.

The sintering in step 3 may be performed in an atmospheric gas, including air, carbon dioxide (CO₂), nitrogen (N₂), or argon (Ar). When the sintering is performed in an oxidizing gas atmosphere such as air or carbon dioxide, or in a nitrogen (N₂) gas atmosphere or inert gas atmosphere such as argon, the O/U ratio (ratio between oxygen elements and uranium elements) is adjustable according to the sintering temperature. Accordingly, the advantage of an easy removal of the fission products (which are single metal components) is provided.

In the sintering of green pellets in step 3, the sintering time may preferably be between 1 and 10 h. If the sintering time is less than 1 h, the mechanical strength of the sintered pellets is so weak that these can be broken even with a small shock, thus making the handling thereof inconvenient. If the sintering time exceeds 10 h, the pores within the sintered pellets are coarsely formed, and the formed coarse pores are then not distributed uniformly in the pellet matrix.

The sintering in step 3 produces pellets in the form of UO₂₊ₓ (0.01≦x≦0.67), and accordingly, the atmosphere may be changed to reducing gas during cooling process for reduction, so that UO₂ sintered pellets are produced from UO₂₊ₓ. The reduction process in step 3 allows production of porous and high-quality UO₂ sintered pellets which have no defects such as cracks, and because the produced UO₂ sintered pellets have 2.00 O/U ratio, the electrolytic reduction may be performed as the post-processing more easily. Further, non-vaporized fission product, which is remained after the sintering of step 3, may be vaporized during reduction.

After the sintering of step 3, UO₂ sintered pellets may be fabricated at sintering temperature in reducing atmosphere for 1 to 6 hr, which may allow reduction into UO₂ to be performed more stably, but not limited thereto.

Meanwhile, the sintering and the reduction of step 3 may be performed consecutively. Accordingly, after the sintering in step 3, hydrogen gas may be introduced to change the atmosphere to reducing atmosphere. As a result, the reduction may consecutively follow the sintering without having any interruption.

If the sintering is performed at air atmosphere, oxidative atmospheric gas may be removed by introducing inert gas such as argon (Ar) first, and then hydrogen gas to create reducing atmosphere may preferably be introduced.

If the sintering is performed in an atmospheric gas such as carbon dioxide, nitrogen, or argon, the reducing atmosphere may be created by directly introducing hydrogen gas, but not limited thereto.

The sintering of step 3 according to a method for fabricating porous UO₂ sintered pellets in one embodiment may additionally include a step of step-wise heating the green pellets formed in step 2 up to the sintering temperature and collecting fission products, and during the step-wise heating of the green pellets to the sintering temperature, the fission product may be distinguished and collected in respective temperature regions at which the volatile fission products are vaporized.

The U₃O₈ powder formed from the spent nuclear fuel includes a variety of volatile and semi-volatile fission products existing therein, and these fission products vaporize at respectively different vaporization temperatures from each other. By way of example, iodine (I) and bromine (Br) vaporize at about 150° C.; technetium (Tc), ruthenium (Ru), molybdenum (Mo), rhodium (Rh), tellurium (Te), or carbon (C) vaporize at about 800° C.; and cesium (Cs), Rubidium (Rb) or cadmium (Cd) vaporize at about 1000° C. While heating the respective fission products with different vaporization temperatures up to the sintering temperature, it is possible to select and use suitable filters to collect the vaporizing fission products, respectively. Therefore, it is possible to more effectively collect the fission products vaporizing at respective temperatures of heating until the sintering temperature, by using suitable filters, and it is also possible to treat the spent filters with the fission products collected thereat.

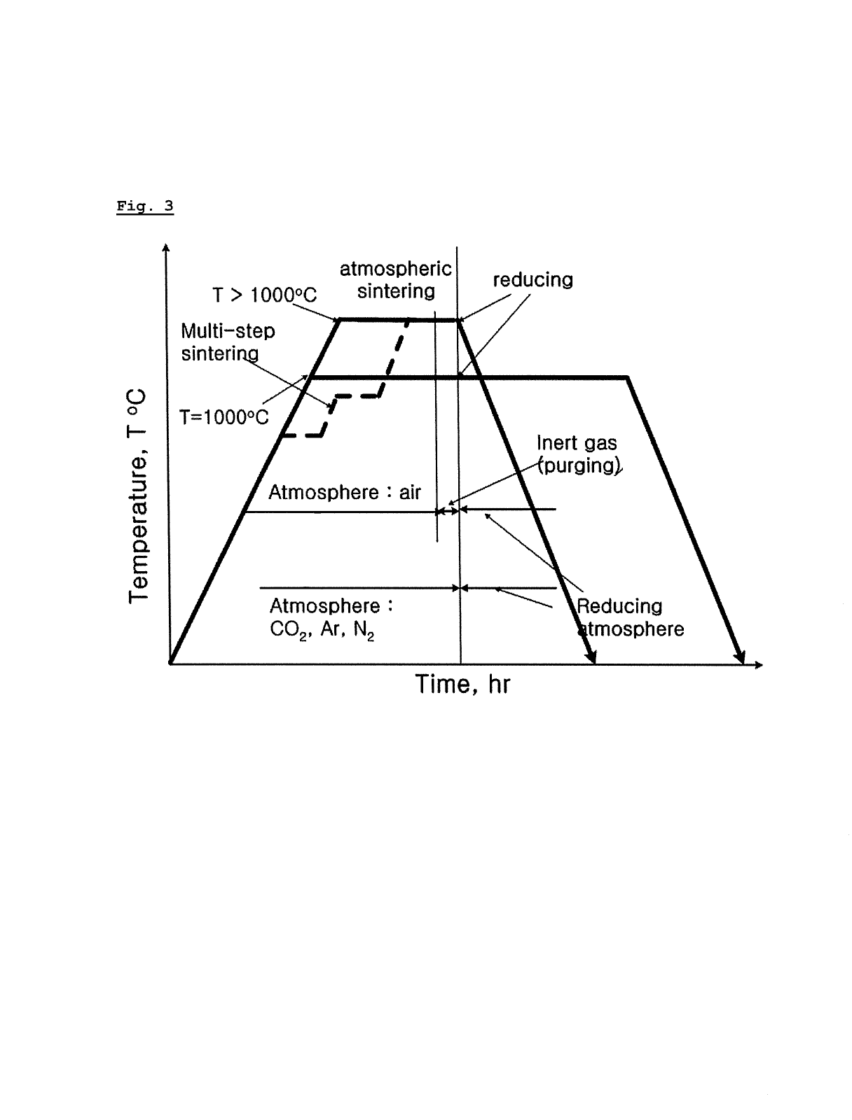

As schematically illustrated through the graph of FIG. 3, the method for fabricating porous UO₂ sintered pellets according to one embodiment changes the atmosphere to reducing atmospheric gas for the reduction during the cooling that follows the removal of the volatile fission products in the high-temperature sintering process. Accordingly, it is possible to remove the fission products with increased efficiency compared to the conventional art, and because it is possible to fabricate the sintered pellets with 2.00 O/U ratio, efficiency of electrolytic reduction improves and respective processes are facilitated.

Meanwhile, the method for fabricating porous UO₂ sintered pellets according to an embodiment may also use raw powder including plutonium oxide (PuO₂), or gadolinium oxide (Gd₂O₃) in addition to nuclear fuel (UO₂), in which case the method can be implemented to produce nuclear fuel of low density such as UO₂—PuO₂, UO₂—Gd₂O₃, or the like, but the embodiment is not limited to any specific example.

In one embodiment, porous UO₂ sintered pellets fabricated using the method explained above are provided.

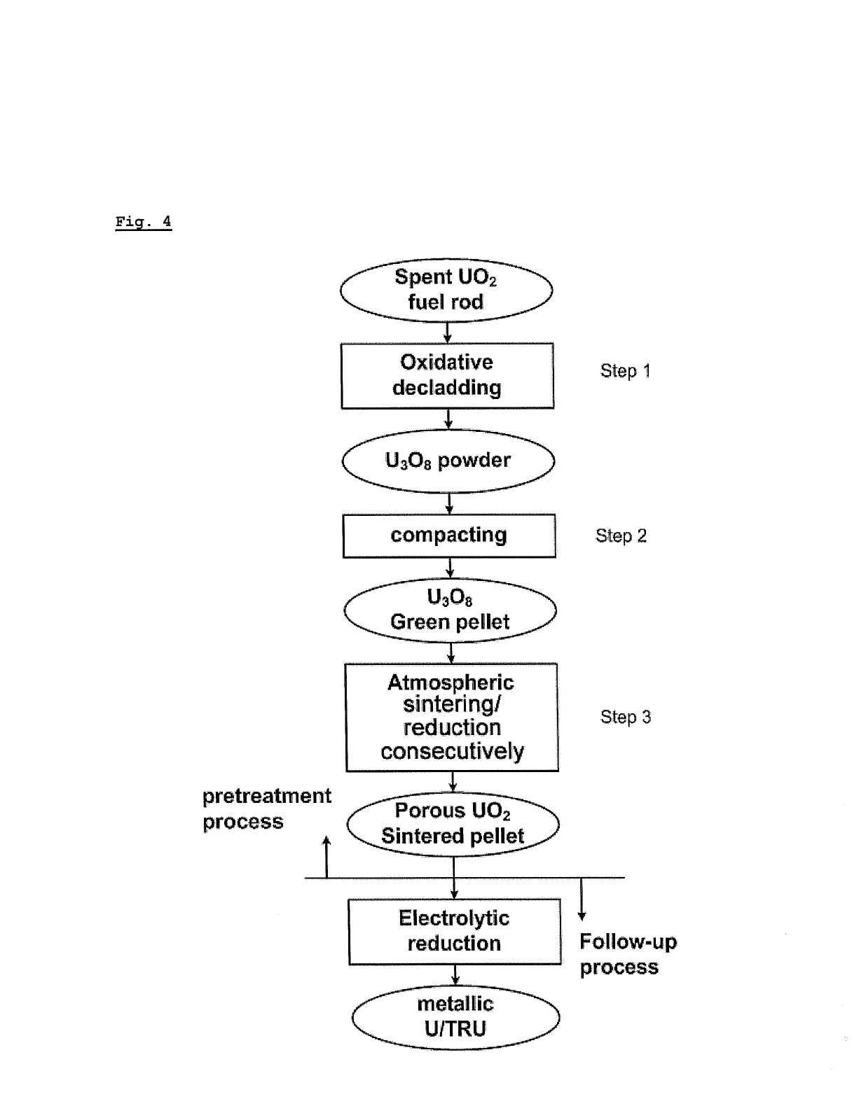

In one embodiment, porous UO₂ sintered pellets are sufficiently removed of volatile fission product, have a 2.00 O/U ratio, and also have a number of pores. Referring to FIG. 4, since electrolyte permeates efficiently during the follow-up electrolytic reduction process, the electrolytic reduction velocity increases. Accordingly, the efficiency of the electrolytic reduction process of the pyroprocess is increased, and the electrolytic reduction process can be performed with easier operation.

Further, the porous UO₂ sintered pellet has 45 to 85% of the theoretical density (T.D.), and preferably, 65 to 75% T.D. If the sintered pellets have the above-mentioned range of theoretical density, both the porosity and rigidity are ensured, and thus sintered pellets are not easily deformed. Further, because most pores are open, the permeation of the electrolyte is facilitated during electrolytic reduction.

Furthermore, an embodiment provides a method for process electrolytic reduction using porous UO₂ sintered pellets fabricated through the above-mentioned method.

The pyroprocess used to recycle spent nuclear fuel includes electrolytic reduction, electro-refining, and electro-winning, through which it is possible to recover the nuclear fuel in metal form. The porous UO₂ sintered pellets fabricated according to an embodiment may be used to recover the metallic nuclear fuel in the pyroprocessing, and to this end, may be used in the electrolytic reduction process.

Accordingly, an embodiment provides a method for performing an electrolytic reduction process using the porous UO₂ sintered pellets fabricating as explained above.

In one embodiment, the method for performing the electrolytic reduction process using porous UO₂ sintered pellets may include the following steps: immersing porous UO₂ sintered pellets in high-temperature molten salt, and preferably, in LiCl—Li₂O solution; and supplying current. Accordingly, it is possible to generate a metalized form containing uranium (U), a transuranic element (TRU), and a fission product (FP) through the electrolytic reduction process. However, the method for the electrolytic reduction process using the porous UO₂ sintered pellets according to an embodiment is not limited to the specific example only, and accordingly, another method and apparatus capable of performing the electrolytic reduction of the porous UO₂ sintered pellets may be adequately implemented.

An embodiment will be explained in greater detail below with reference to Examples. However, the Examples are provided only for illustrative purposes, and therefore, an embodiment is not limited to the specific Examples explained below.

### EXAMPLE 1

### Fabrication 1 of Porous UO₂ Sintered Pellets

U₃O₈ powder was produced using an unirradiated UO₂ sintered pellets, instead of an irradiated uranium dioxide (UO₂) sintered pellets from a furnace. The unirradiated UO₂ sintered pellets exhibited approximately 96% T.D. for the sintered density. The unirradiated UO₂ sintered pellets were oxidized at 450° C. in an air atmosphere for 4 h, and as a result of oxidation of UO₂ sintered pellets into U₃O₈, a density decrease and subsequent volume expansion, U₃O₈ powder was produced. The produced U₃O₈ powder has an average particle size of 10 μm, and a specific surface area of 0.56˜0.74 m²/g.

The produced U₃O₈ powder was charged into press dies, and fabricated into cylindrical pellets (diameter: 10 mm, length: 8 mm, weight: about 4 g) under three compacting pressure conditions of 100, 300, and 500 MPa, with a deviation of the compacting pressure staying within 10 MPa. The green densities of the fabricated green pellets were 58-59% T.D. under a compacting pressure of 100 MPa, 67-68% T.D. under 300 MPa, and 71-73% T.D. under 500 MPa (U₃O₈ T.D.: 8.34 g/cm³). After compacting, the green pellets were placed in a zirconia (ZrO₂) boat, charged in a batch-type furnace (Maker; Lenton) and sintered in an air atmosphere under five sintering temperature conditions of 1000° C., 1100° C., 1200° C., 1400° C., and 1600° C. for 2 h.

After sintering, argon (Ar) gas was introduced for purging while the sintering temperature was maintained. Hydrogen gas was then introduced during cooling to create reducing atmosphere, under which UO₂₊ₓ sintered pellets were reduced to UO₂ sintered pellets. Both the heating rate and cooling rate were set to 4° C./min, and as a result, porous UO₂ sintered pellets were fabricated through the sintering and reduction process.

Meanwhile, if the sintering was performed at 1000° C., hydrogen gas for reduction was introduced at 1000° C. to create reducing atmosphere, so that the reduction into UO₂ sintered pellets occurred for 6 hr.

### Example 2

### Fabrication 2 of Porous UO₂ Sintered Pellets

The same U₃O₈ powder as the one used in Example 1 was charged into press dies, and fabricated into cylindrical pellets (diameter: 10 mm, length: 8 mm, weight: about 4 g) under three compacting pressure conditions of 100, 300, and 500 MPa, with a deviation of the compacting pressure staying within 10 MPa. The green densities of the fabricated green pellets were 57-59% T.D. under a compacting pressure of 100 MPa, 66-68% T.D. under 300 MPa, and 71-73% T.D. under 500 MPa (U₃O₈ T.D.: 8.34 g/cm³). After compacting, the green pellets were placed in a zirconia (ZrO₂) boat, charged in a batch-type furnace (Maker; Lenton) and sintered in an CO₂ atmosphere under five sintering temperature conditions of 1000° C., 1100° C., 1200° C., 1400° C., and 1600° C. for 2 h.

After sintering, introduction of argon (Ar) gas for purging was omitted, but hydrogen gas was directly introduced to create reducing atmosphere, under which UO₂₊ₓ sintered pellets were reduced to UO₂ sintered pellets. Both the heating rate and cooling rate were set to 4° C./min, and as a result, porous UO₂ sintered pellets were fabricated through the sintering and reduction process.

Meanwhile, if the sintering was performed at 1000° C., hydrogen gas for reduction was introduced at 1000° C. to create reducing atmosphere, so that the reduction into UO₂ sintered pellets occurred for 6 hr.

### Example 3

### Fabrication 3 of Porous UO₂ Sintered Pellets

Porous UO₂ sintered pellets were fabricated in the same manner as that explained in Example 1, except for the differences that the sintering was performed in a nitrogen (N₂) atmosphere instead of air atmosphere, and that introduction of hydrogen to create reducing atmosphere was directly performed without introduction of argon (Ar) gas.

### Example 4

### Fabrication 4 of Porous UO₂ Sintered Pellets

Porous UO₂ sintered pellets were fabricated in the same manner as that explained in Example 3, except for the difference that the sintering was performed in an argon (Ar) gas atmosphere instead of an air atmosphere.

### Example 5

### Fabrication 5 of Porous UO₂ Sintered Pellets

Green pellets, the same as that used in Example 1, were used. That is, the green pellets were heated with a multi-step procedure, for example, 700° C., 2 h and 900° C., 2 h in an air atmosphere, from which vaporizing fission products at each temperature range were collected. After sintering at 1400° C., 2 h, argon (Ar) gas was introduced for purging, and then hydrogen gas was introduced to create reducing atmosphere so that the UO₂₊ₓ sintered pellets were reduced during cooling. Both the heating and cooling rates were set to 4° C./min, and porous UO₂ sintered pellets were fabricated as a result of the sintering and reduction. The theoretical densities % of the sintered pellets fabricated by multi-step sintering were observed to be almost the same as the theoretical densities % of the sintered pellets fabricated using single-step sintering.

### Example 6

### Fabrication 6 of Porous UO₂ Sintered Pellets

Porous UO₂ sintered pellets were fabricated in the same manner as that explained in Example 5, except for the difference that the hydrogen gas was directly introduced to create reducing atmosphere without introducing argon (Ar) gas for purging after the sintering and that the UO₂₊ₓ sintered pellets were reduced by cooling. The theoretical densities % of the sintered pellets fabricated by multi-step sintering were observed to be almost the same as the theoretical densities % of the sintered pellets fabricated using single-step sintering.

### Example 7

### Fabrication 7 of Porous UO₂ Sintered Pellets

Porous UO₂ sintered pellets were fabricated in the same manner as that explained in Example 5, except for the difference that the sintering was performed in a nitrogen (N₂) atmosphere instead of air atmosphere and that hydrogen gas was directly introduced to create reducing atmosphere after the sintering without introducing argon (Ar) gas. The theoretical densities % of the sintered pellets fabricated by multi-step sintering were observed to be almost the same as the theoretical densities % of the sintered pellets fabricated using single-step sintering.

### Example 8

### Fabrication 8 of Porous UO₂ Sintered Pellets

Porous UO₂ sintered pellets were fabricated in the same manner as that explained in Example 7, except for the difference that the sintering was performed in an argon (Ar) gas atmosphere instead of a nitrogen (N₂) atmosphere. The theoretical densities % of the sintered pellets fabricated by the multi-step sintering were observed to be almost the same as the theoretical densities % of the sintered pellets fabricated using single-step sintering.

### Example 9

### Electrolytic Reduction Using Porous UO₂ Sintered Pellets 1

350 g of LiCl (99%, Alfa Aesar) and 3.55 g of Li₂O (99.5%, Cerac) were put into a stainless 316 crucible, heated in an argon (Ar) gas atmosphere, at 650° C. As a result, LiCl-1 wt % Li₂O molten salt was obtained. After that, porous UO₂ sintered pellets fabricated under a compacting pressure of 100 MPa and at a sintering temperature of 1400° C. were put in a stainless 316 cathode basket surrounded by a 325 mesh sieve (45 μm sieve openings) and immersed in molten salt. Accordingly, electrolytic reduction was performed, in which a voltage of 3.1 V was consistently supplied at a temperature of 650° C. The porous UO₂ sintered pellets fabricated according to the invention, which underwent electrolytic reduction, had average density of about 61.0% T.D., and the electrolytic reduction rate achieved as approximately 70% or greater. Further, the porous UO₂ sintered pellets maintained their shape even after the electrolytic reduction was completed.

### Example 10

### Electrolytic Reduction Using Porous UO₂ Sintered Pellets 2

The electrolytic reduction was performed in the same manner as applied in Example 9, except for the difference that the porous UO₂ sintered pellets (average sintered density: about 69.7%), which were fabricated under a compacting pressure of 100 MPa and at a sintering temperature of 1400° C. (Example 2), were used. The electrolytic reduction rate was achieved as approximately 96% or greater. Further, the porous UO₂ sintered pellets maintained their shape even after the electrolytic reduction was completed.

### Example 11

### Electrolytic Reduction Using Porous UO₂ Sintered Pellets 3

The electrolytic reduction was performed in the same manner as applied in Example 9, except for the difference that the porous UO₂ sintered pellets (average sintered density: about 80.3%), which were fabricated under a compacting pressure of 500 MPa and at a sintering temperature of 1600° C. (Example 2), were used. The electrolytic reduction rate was achieved as approximately 90% or above. Further, the porous UO₂ sintered pellets maintained their shape even after the electrolytic reduction was completed.

### Experimental Example 1

### Density Analysis of Porous UO₂ Sintered Pellets

To analyze the densities of porous UO₂ sintered pellets fabricated according to

Examples 1 to 4, an immersion method was used to measure the densities and the results are presented in Table 1.

TABLE 1

| | | Density (%, T.D.) of sintered pellets | | | |
|---|---|---|---|---|---|
| | | after sintering and reducing | | | |
| Atmospheric | Compacting | Sintering atmospheric gas | | | |
| sintering temp | pressure | Air | CO₂ | N₂ | Inert Ar |
| T(° C.) | (MPa) | (Ex. 1) | (Ex. 2) | (Ex. 3) | (Ex. 4) |
| 1000 | 100 | 50.9 | 49.2 | 50.3 | 49.5 |
| | 300 | 56.6 | 56.6 | 56.6 | 55.9 |
| | 500 | 59.6 | 60.4 | 60.5 | 59.8 |
| 1100 | 100 | 52.9 | 52.8 | 53.1 | 52.2 |
| | 300 | 58.7 | 61.0 | 60.5 | 60.4 |
| | 500 | 61.7 | 66.5 | 64.3 | 66.2 |
| 1200 | 100 | 57.2 | 56.3 | 56.4 | 55.3 |
| | 300 | 62.0 | 63.6 | 63.2 | 61.9 |
| | 500 | 64.8 | 67.3 | 67.0 | 66.4 |
| 1400 | 100 | 61.1 | 69.7 | 68.3 | 67.5 |
| | 300 | 65.9 | 76.3 | 76.4 | 75.1 |
| | 500 | 68.0 | 79.2 | 80.6 | 79.8 |
| 1600 | 100 | 63.9 | 69.2 | 71.0 | 69.5 |
| | 300 | 70.2 | 76.0 | 78.1 | 76.1 |
| | 500 | 74.9 | 80.3 | 82.1 | 79.8 |

As Table 1 indicates, porous UO₂ sintered pellets fabricated according to Examples 1 to 4 of the present invention had final sintered densities after a reduction ranging between approximately 45% T.D. and 85% T.D., which confirmed that porous UO₂ sintered pellets according to the present invention can be used in the electrolytic reduction of the pyroprocessing to recover metallic nuclear fuel with improved efficiency and enhanced operability of the electrolytic reduction processing.

### Experimental Example 2

### Analysis of O/U Ratio of Porous UO₂ Sintered Pellets

To analyze the O/U ratio of the porous UO₂ sintered pellets fabricated according to Examples 1 to 4, an analysis and measurement were performed according to ASTM C696.

As a result of an ASTM C696 analysis of the O/U ratio of the porous UO₂ sintered pellets fabricated according to Examples 1 to 4, it was confirmed that the O/U ratios of all the fabricated sintered pellets were 2.00. Accordingly, it was confirmed that high-quality porous UO₂ sintered pellet with an O/U ratio of 2.00 can be fabricated according to the fabrication method of the present invention.

### Experimental Example 3

### Observation on the Microstructure of Sintered Pellets

The following test was conducted to investigate the microstructure of porous UO₂ sintered pellets fabricated according to Examples 1 to 4. The porous UO₂ sintered pellets fabricated under the compacting of pressure of 300 MPa were used as the sample.

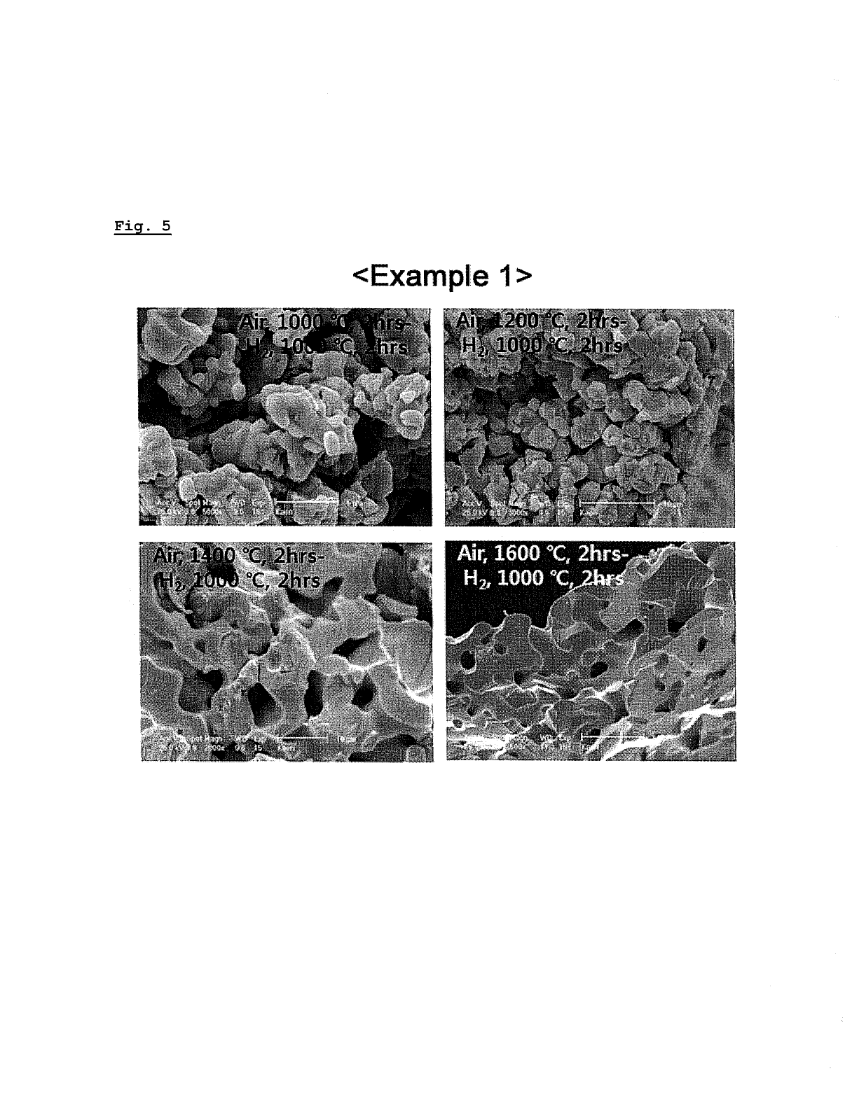

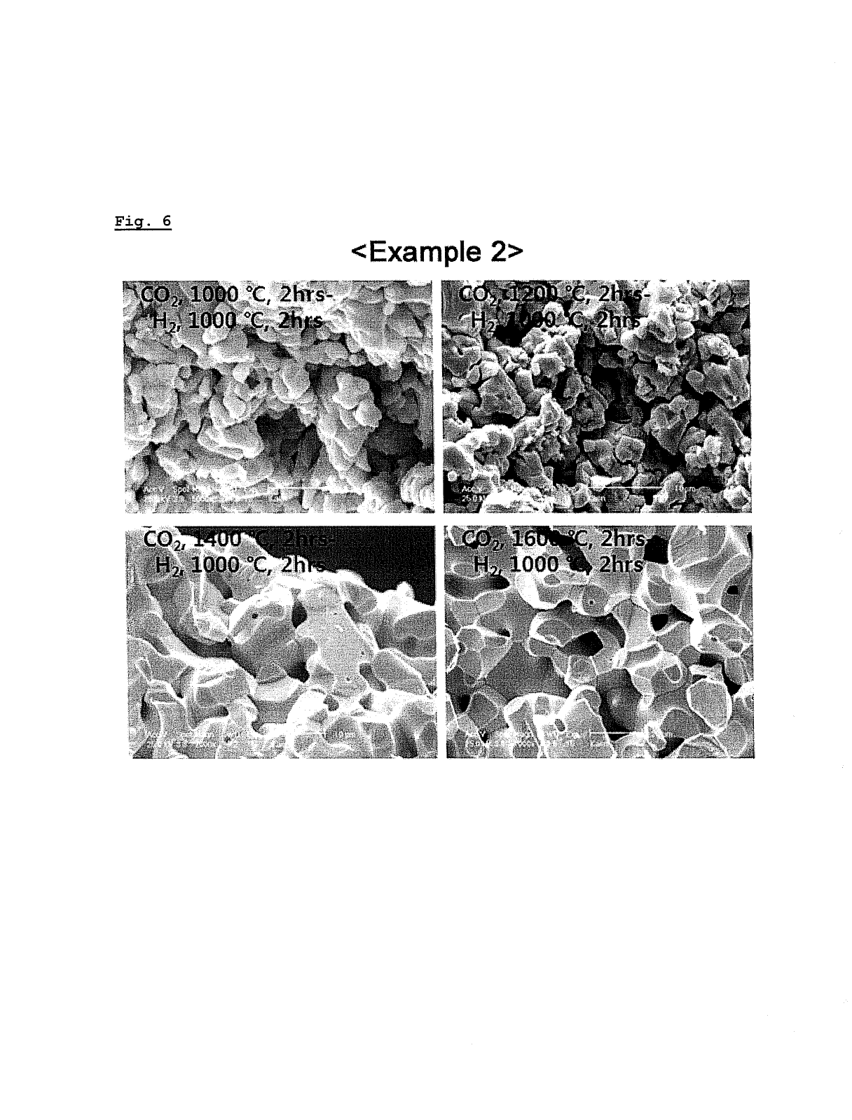

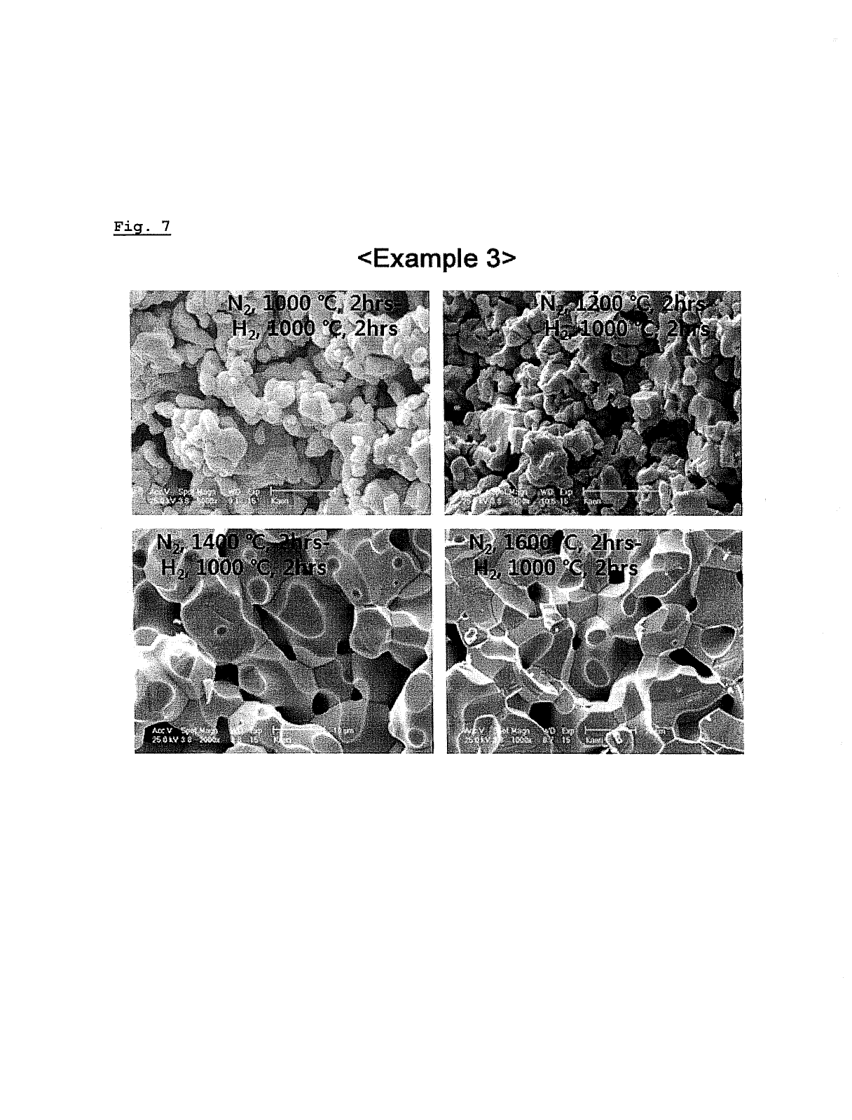

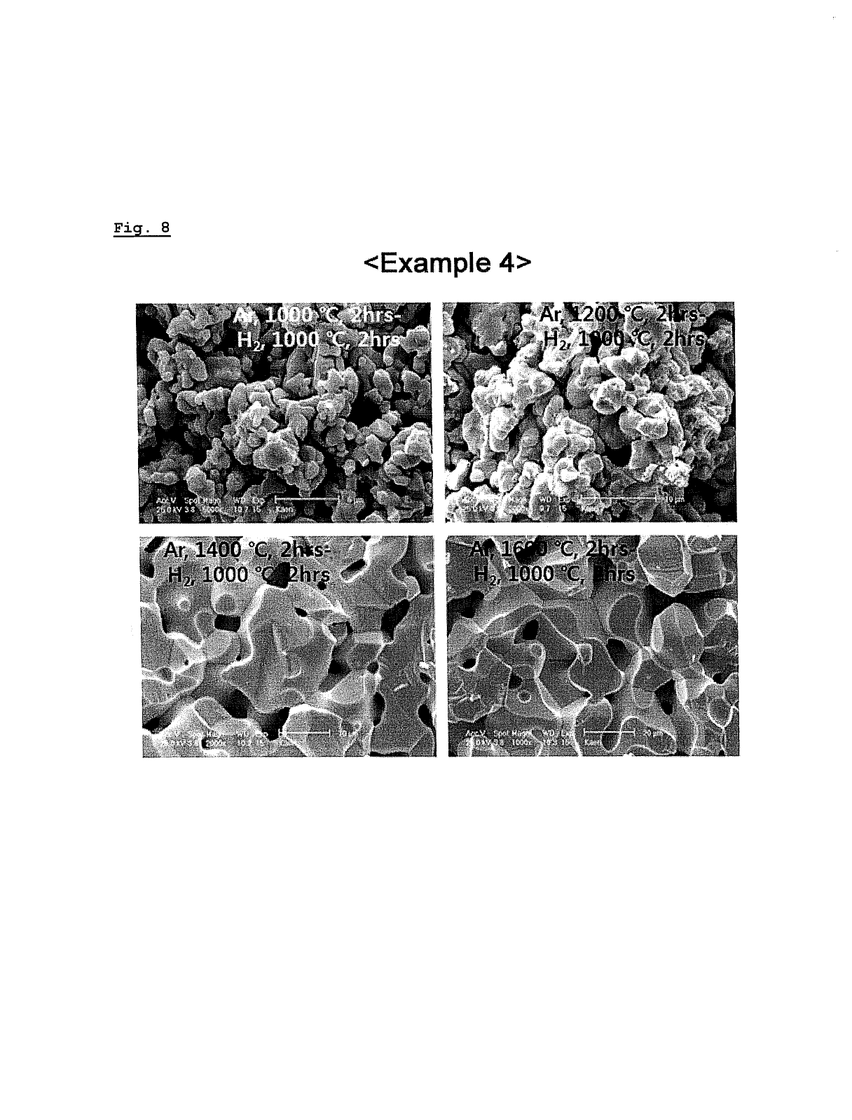

The fracture surfaces of the UO sintered pellets of Examples 1 to 4 were observed by SEM (Scanning Electron Microscope, Model: XL 30, Philips), and the results are provided in FIGS. 5 to 8, in which the figures show the results obtained after the sintering was conducted in an air atmosphere, a carbon dioxide (CO₂) gas atmosphere, a nitrogen (N₂) gas atmosphere, and an argon (Ar) gas atmosphere, respectively.

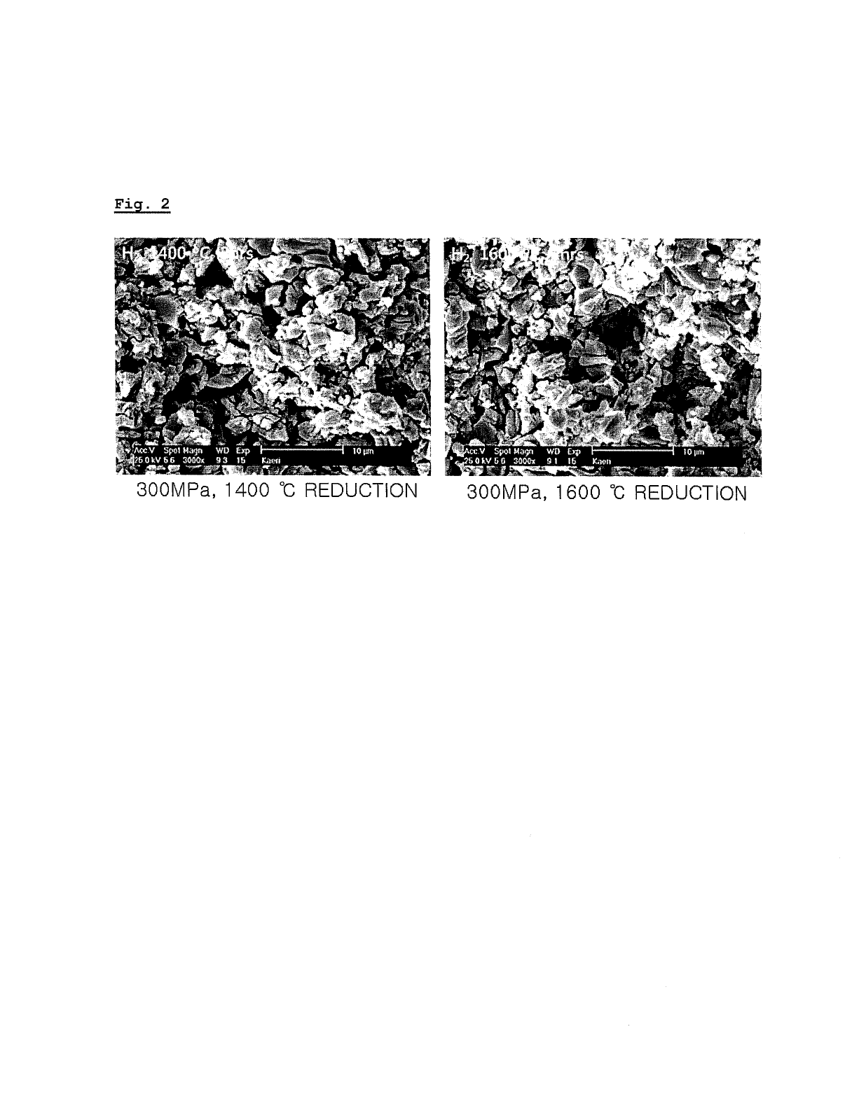

Referring to FIGS. 5 to 8, the pores were more rounded as the temperature of the sintering increased. Further, compared to the sintered pellets (FIG. 2) fabricated by sintering U₃O₈ green pellets in a high-temperature reducing atmosphere, greater particle growth was observed which was attributed to the increased in the contacting areas among the particles. From the above findings, it was confirmed that the porous UO₂ sintered pellets by the fabrication method according to the present invention exhibited porous microstructure, which in turn facilitated permeation of electrolytes during the follow-up process (i.e., electrolytic reduction) and increased the electrolytic reduction rate.

While the present invention has been particularly shown and described with reference to exemplary embodiments thereof, it will be understood by those skilled in the art that various changes in form and details may be made therein without departing from the spirit and scope of the invention as defined by the appended claims.

1. A method for fabricating porous UO₂ sintered pellets to be fed into an electrolytic reduction process for the purpose of metallic nuclear fuel recovery, comprising the following steps:
forming a powder containing U₃O₈ by oxidizing a spent nuclear fuel containing uranium dioxide (UO₂) (step 1);
fabricating U₃O₈ green pellets by compacting the powder formed in step 1 (step 2); and
fabricating UO₂ sintered pellets by sintering the U₃O₈ green pellets fabricated in step 2 at 1000 to 1600° C., in an atmospheric gas, and cooling the same for reduction, by changing the atmosphere to a reducing atmospheric gas (step 3).

2. The method as set forth in claim 1, which further comprises a step of collecting the fission products through step-wise heating the green pellets in step 2 up to the sintering temperature before step 3.

3. The method as set forth in claim 1, wherein the oxidizing in step 1 is performed at 400 to 500° C., in an oxidizing atmosphere.

4. The method as set forth in claim 1, wherein the fabrication of the green pellets in step 2 is performed under a compacting pressure of 100 to 500 MPa.

5. The method as set forth in claim 1, wherein the sintering in step 3 is performed in one atmosphere selected from a group consisting of air, carbon dioxide, nitrogen, and argon.

6. The method as set forth in claim 1, wherein the sintering in step 3 is performed for 1 to 10 hours.

7. The method as set forth in claim 1, wherein the reducing atmosphere in step 3 is a hydrogen gas-included atmosphere.

8. The method as set forth in claim 1, wherein the sintering and the reducing in step 3 is performed consecutively.

9. The method as set forth in claim 1, wherein the UO2 sintered pellets fabricated in step 3 are porous.

10. The method as set forth in claim 9, wherein the porous UO₂ sintered pellets have 45 to 85% of the theoretical density (T.D.).

11. The method as set forth in claim 9, wherein the porous UO₂ sintered pellets have 65 to 75% of the theoretical density (T.D.).

12. The method as set forth in claim 1, further comprising:
performing an electrolytic reduction process using the porous UO₂ sintered pellets.
